(19) United States
(12) Patent Application Publication
(10) Pub. No.: US 2015/0146989 A1
(43) Pub. Date: May 28, 2015

(54) IMAGE PROCESSING APPARATUS, IMAGE PROCESSING METHOD, AND PROGRAM

(71) Applicant: CANON KABUSHIKI KAISHA, Tokyo (JP)

(72) Inventors: Hirotaka Shiiyama, Yokohama-shi (JP); Masahiro Matsushita, Yokohama-shi (JP)

(21) Appl. No.: 14/552,116

(22) Filed: Nov. 24, 2014

(30) Foreign Application Priority Data
Nov. 26, 2013 (JP) 2013-244127

(51) Int. Cl. G06K 9/62; G06K 9/46

(52) U.S. Cl. CPC G06K 9/6202; G06K 9/4604
USPC 382/197

(57) ABSTRACT

An image processing method includes acquiring the number of feature vectors similar to at least one specific feature vector, including the at least one specific feature vector, among feature vectors of a plurality of keypoints in a comparison source image, and the number of feature vectors similar to the at least one specific feature vector in at least one comparison destination image, and comparing the comparison source image with the at least one comparison destination image by using, as a value for evaluating a similarity between the comparison source image and the at least one comparison destination image, a smaller value instead of a larger value of the numbers of feature vectors acquired with respect to the at least one specific feature vector.

### BACKGROUND OF THE INVENTION

1. Field of the Invention

The present invention relates to a technique for comparing and searching for images by using local feature vectors in images.

2. Description of the Related Art

There has been proposed a method for searching for similar images by using local feature vectors in images. This method first extracts interest points (keypoints) from images. (For example, refer to C. Harris and M. J. Stephens, “A combined corner and edge detector,” In Alvey Vision Conference, pages 147-152, 1988.) Then, based on the relevant keypoints and peripheral image information, the method calculates feature vectors (local feature vectors) corresponding to the relevant keypoints. (For example, refer to David G. Lowe, “Distinctive Image Features from Scale-Invariant Keypoints,” International Journal of Computer Vision, 60, 2 (2004), pp. 91-110.)

A technique based on local feature vectors defines local feature vectors as information including a plurality of elements which are rotation-invariant and scale-invariant. This enables image search even after an image has been rotated, or enlarged or reduced. A local feature vector is generally represented as a vector. However, the local feature vector is rotation-invariant and scale-invariant only on a theoretical basis. In actual digital images, a slight variation arises between the local feature vector before image rotation, enlargement, or reduction processing and the related local feature vector after the relevant processing.

To extract rotation-invariant local feature vectors, for example, a method discussed in David G. Lowe, “Distinctive Image Features from Scale-Invariant Keypoints,” International Journal of Computer Vision, 60, 2 (2004), pp. 91-110 calculates the main direction based on pixel patterns of local areas around a keypoint. At the time of local feature vector calculation, the method rotates the local areas with reference to the main direction to normalize the direction. Further, to calculate scale-invariant local feature vectors, the method internally generates images with different scales, extracts keypoints from images with respective scales, and calculates local feature vectors. A set of a series of images with different scales internally generated is generally referred to as a scale space.

A plurality of keypoints is extracted from one image by the above-described method. In image search using local feature vectors, the method compares local feature vectors calculated from respective keypoints to perform image matching. With a voting method used in many cases (for example, refer to Japanese Patent Application Laid-Open No. 2009-284084), if a registered image (hereinafter also referred to as a comparison destination image) contains a keypoint having a feature vector similar to the local feature vector of each keypoint extracted from a comparison source image, one vote is cast for the registered image. It is determined that a registered image having a larger number of votes has a higher degree of similarity to the comparison source image.

### SUMMARY OF THE INVENTION

The present invention(s) are directed to providing an image processing apparatus for suitably evaluating the number of keypoints having similar local feature vectors in order to suppress a determination that at least one comparison destination image has an excessive degree of similarity to a comparison source image. The present invention(s) are also directed to providing a method of evaluation and a program for evaluation.

At least one embodiment of the image processing apparatus according to the present invention(s) has the following configuration.

According to at least one aspect of the present invention(s), the image processing apparatus includes an acquisition unit configured to acquire the number of feature vectors similar to at least one specific feature vector, including the at least one specific feature vector, among feature vectors of a plurality of keypoints in a comparison source image, and the number of feature vectors similar to the at least one specific feature vector in at least one comparison destination image, and a comparison unit configured to compare the comparison source image with the at least one comparison destination image by using, as a value for evaluating a similarity between the comparison source image and the at least one comparison destination image, a value smaller than a larger value of the numbers of feature vectors acquired with respect to the at least one specific feature vector.

Further features of the present invention will become apparent from the following description of exemplary embodiments with reference to the attached drawings.

### BRIEF DESCRIPTION OF THE DRAWINGS

FIG. 1 illustrates an example of a voting status at a time when the “many-to-one correspondence” of local feature vectors has occurred.

FIG. 2 is a block diagram illustrating an example of a functional configuration of an image comparison apparatus according to a first exemplary embodiment.

FIG. 3 is a flowchart illustrating an example of image comparison processing according to the first exemplary embodiment.

FIG. 4 is a flowchart illustrating an example of image feature vector group extraction processing according to the first exemplary embodiment.

FIG. 5 illustrates an example of reduced image generation processing according to the first exemplary embodiment.

FIGS. 6A and 6B illustrate examples of segmentalization of a two-dimensional feature vector space into a lattice shape according to the first exemplary embodiment.

FIG. 7 is a flowchart illustrating an example of processing for comparing the image feature vector appearance frequencies for each quantization value according to the first exemplary embodiment.

FIG. 8 is a flowchart illustrating an example of processing for comparing the image feature vector appearance frequencies for each quantization value according to a second exemplary embodiment.

FIG. 9 illustrates an example of weighting in a two-dimensional feature vector space according to the second exemplary embodiment.

FIG. 10 is a block diagram illustrating an example of a functional configuration of an image comparison apparatus according to a third exemplary embodiment.

FIG. 11 is a flowchart illustrating an example of image comparison processing according to the third exemplary embodiment.

FIG. 12 is a flowchart illustrating an example of processing for recalculating the image feature vector appearance frequency for each quantization value according to the third exemplary embodiment.

FIG. 13 is a flowchart illustrating an example of image comparison processing according to a fourth exemplary embodiment.

FIG. 14 is a block diagram illustrating an example of a functional configuration of an image comparison apparatus according to a fifth exemplary embodiment.

FIG. 15 is a flowchart illustrating an example of image registration processing according to the fifth exemplary embodiment.

FIG. 16 illustrates an example of a registered database in which the image feature vector appearance frequency for each quantization value is associated with a comparison destination image according to the fifth exemplary embodiment.

FIG. 17 is a flowchart illustrating an example of image search processing according to the fifth exemplary embodiment.

FIG. 18 is a flowchart illustrating an example of processing for comparing the image feature vector appearance frequencies for each quantization value according to the fifth exemplary embodiment.

FIG. 19 is a block diagram illustrating an example of a hardware configuration of the apparatus according to the first to the fifth exemplary embodiments.

FIG. 20 illustrates an example of comparison of the number of feature vectors for each quantization value of the local feature vector.

FIGS. 21A and 21B illustrate examples of comparison of the number of feature vectors for each quantization value in a two-dimensional feature vector space.

### DESCRIPTION OF THE EMBODIMENTS

Various exemplary embodiments, features, and aspects of the invention will be described in detail below with reference to the drawings.

A first exemplary embodiment of the present invention will be described below with reference of the accompanying drawings. An image processing apparatus according to the first exemplary embodiment extracts image feature vector group from a comparison source image and image feature vector group from a comparison destination image, compares these image feature vector groups, and obtains a result of the comparison. Hereinafter, the image processing apparatus is referred to as an image comparison apparatus.

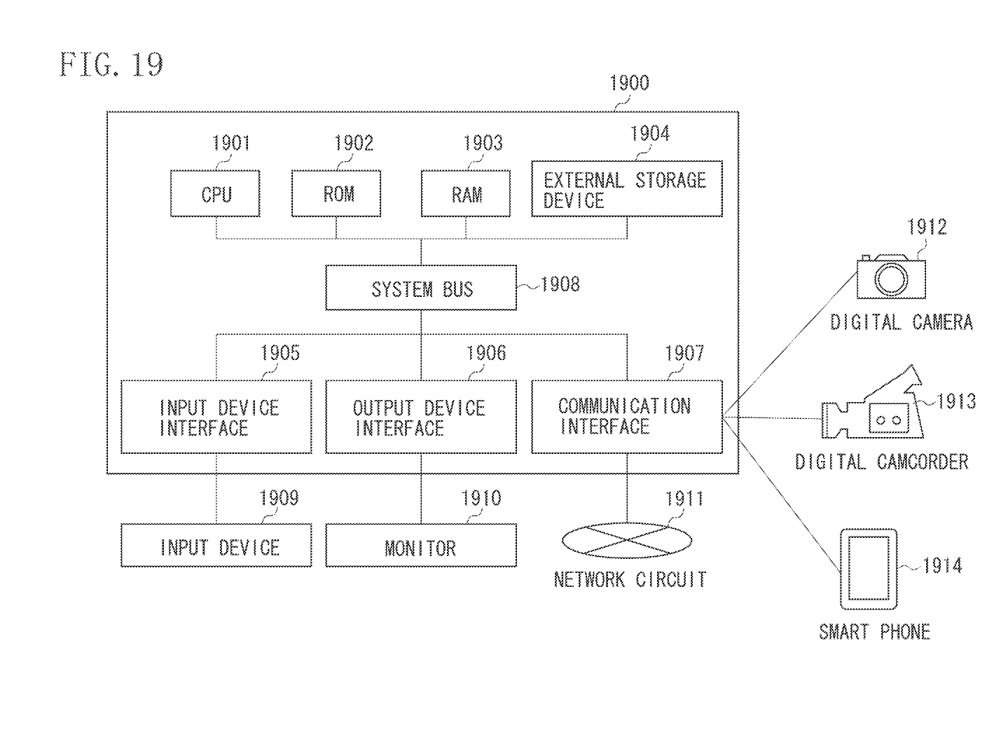

A configuration of a computer apparatus constituting a server apparatus or a client apparatus according to the first exemplary embodiment will be described below with reference to the block diagram illustrated in FIG. 19. The server apparatus and the client apparatus may be implemented by a single computer apparatus, or implemented by a plurality of computer apparatuses having distributed functions as required. When the server apparatus and the client apparatus are composed of a plurality of computer apparatuses, these apparatuses are connected with each other via a local area network (LAN) so that they can communicate with each other. A computer apparatus can be implemented by an information processing apparatus, such as a personal computer (PC) or a workstation (WS).

Referring to FIG. 19, a central processing unit (CPU) 1901 controls the entire computer apparatus 1900. A read only memory (ROM) 1902 stores invariant programs and parameters. A random access memory (RAM) 1903 temporarily stores programs and data supplied from an external apparatus. An external storage device 1904 is a device, such as a hard disk or a memory card fixedly installed on the computer apparatus 1900. The external storage device 1904 may include a flexible disk (FD), an optical disk such as a compact disk (CD), a magnetic card, an integrated circuit (IC) card, and a memory card detachably attached to the computer apparatus 1900. An input device interface 1905 interfaces with an input device 1909 (e.g., a pointing device or a keyboard) to receive a user operation and inputting data. An output device interface 1906 interfaces with a monitor 1910 for displaying data stored in the computer apparatus 1900 and supplied data. A communication interface 1907 connects the computer apparatus 1900 with a network line 1911, such as the Internet, a digital camera 1912, a digital camcorder 1913, and a smart phone 1914. A system bus 1908 is a transmission line for connecting the units 1901 to 1907 so that they can communicate with each other.

Each operation described below is implemented when the CPU 1901 executes a program stored in a computer-readable storage medium, such as the ROM 1902.

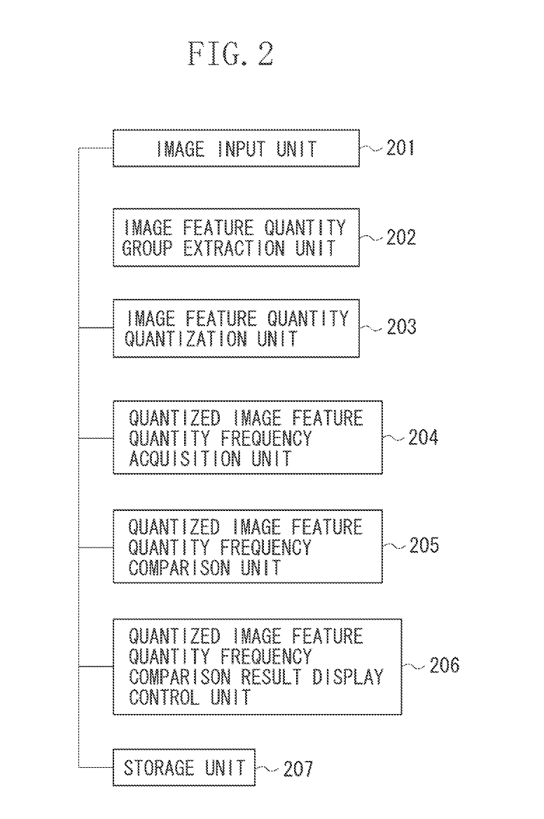

FIG. 2 is a block diagram illustrating an example of a functional configuration of the image comparison apparatus according to the first exemplary embodiment. Operations of each unit illustrated in FIG. 2 will be described in detail below.

Referring to FIG. 2, an image input unit 201 inputs a comparison source image and a comparison destination image. An image feature vector group extraction unit 202 extracts the image feature vector groups in the comparison source image and the comparison destination image input from the image input unit 201. An image feature vector quantization unit 203 quantizes the image feature vector groups extracted by the image feature vector group extraction unit 202 to generate respective quantized image feature vector groups. For each of the quantized image feature vector groups generated by the image feature vector quantization unit 203, a quantized image feature vector frequency acquisition unit 204 acquires the image feature vector appearance frequencies for each quantization value. A quantized image feature vector frequency comparison unit 205 compares the image feature vector appearance frequencies for each quantization value in the comparison source image and the comparison destination image generated by the quantized image feature vector frequency acquisition unit 204. The quantized image feature vector frequency comparison unit 205 evaluates the similarity between the comparison source image and the comparison destination image based on the result of the comparison. A quantized image feature vector frequency comparison result display unit 206 displays the result of the comparison obtained by the quantized image feature vector frequency comparison unit 205. The storage unit 207, such as a memory and a hard disk drive (HDD), stores data currently being processed.

The above-described units are comprehensively controlled by the CPU 1901. Control circuits, such as an application specific integrated circuit (ASIC) for operating in collaboration with the CPU 1901, may function as these units. Further, these units may be implemented by the cooperation between the CPU 1901 and a circuit for controlling operations of the image processing apparatus. Further, the CPU 1901 may be a single CPU or a plurality of CPUs. In the latter case, the plurality of CPUs can perform processing in a distributed way. Further, the plurality of CPUs may be disposed in a single computer or in a plurality of physically different computers. A unit implemented at a time when the CPU 1901 executes a program may be implemented by a dedicated circuit.

The present exemplary embodiment focuses attention on the following problem that the voting method based on the conventional technique has. When the comparison source image contains N keypoints having similar local feature vectors, and the comparison destination image contains only one keypoint having a similar local feature vector, the comparison destination image will procure N votes. Specifically, N keypoints in the comparison source image and one keypoint in the comparison destination image are related on a many-to-one basis, and, it will be determined that the comparison destination image which originally is not similar to the comparison source image has a high degree of similarity to the comparison source image based on a number of votes. It turned out that the conventional voting method has in principle such a drawback that the above-described “many-to-one correspondence” of local feature vectors is permitted. The above-described problem arises not only from the “many-to-one correspondence”. A similar problem arises when the comparison source image contains N keypoints having similar local feature vectors, and the comparison destination image contains M keypoints having similar local feature vectors (M is substantially different from N, and may be larger or smaller than N).

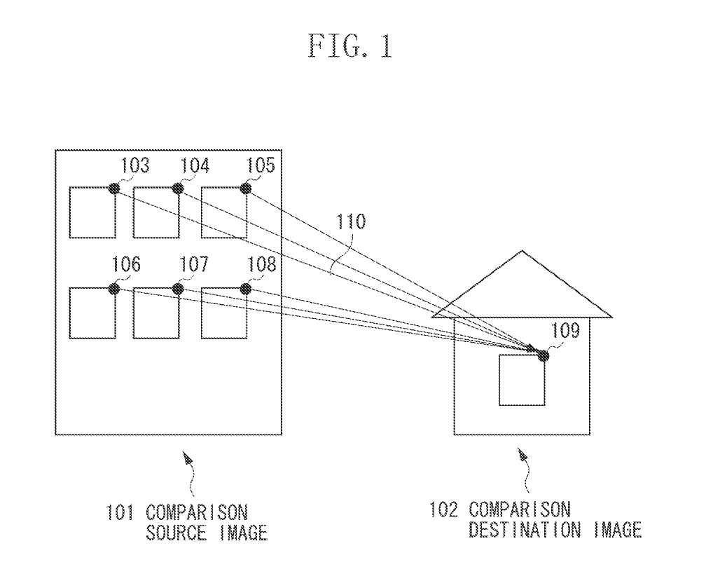

FIG. 1 illustrates an example of a voting status at a time when the “many-to-one correspondence” of local feature vectors has occurred. Referring to FIG. 1, there is a comparison source image 101 and a comparison destination image 102. There are six windows on a building in the comparison source image 101, and six keypoints 103 to 108 are extracted from the upper right portion of each window. There is one window on a building in the comparison destination image 102, and a keypoint 109 is extracted from the upper right portion of the window. It is assumed that all of local feature vectors calculated from these keypoints are similar to each other.

With the conventional voting method, if a comparison destination image contains a keypoint having a local feature vector similar to the local feature vector in a comparison source image, one vote is cast for the comparison destination image. With the conventional voting method, since the local feature vector of the keypoint 103 is similar to the local feature vector of the keypoint 109, one vote is cast for the comparison destination image. Further, since the local feature vector of the keypoint 104 is similar to the local feature vector of the keypoint 109, another one vote is cast for the comparison destination image. Further, since the local feature vectors of the keypoints 105 to 108 are similar to the local feature vector of the keypoint 109, another 4 votes are cast for the comparison destination image. It is desirable that one vote is cast for the comparison destination image 102 since it has only one keypoint similar to the comparison source image 101. In this example, however, a total of 6 votes will be cast for the comparison destination image 102. As a result, the comparison destination image which should originally have a low degree of similarity to the comparison source image has been searched showing a high degree of similarity.

There is a plurality of similar partial images in the comparison source image 101 or the comparison destination image 102. Therefore, the above-described problem often arises, for example, in a case where there is a plurality of similar local feature vectors. In the example illustrated in FIG. 1, since there is a plurality of building windows as partial images, there is a plurality of keypoints (the keypoints 103 to 108) having similar local feature vectors.

### [Image Comparison Processing]

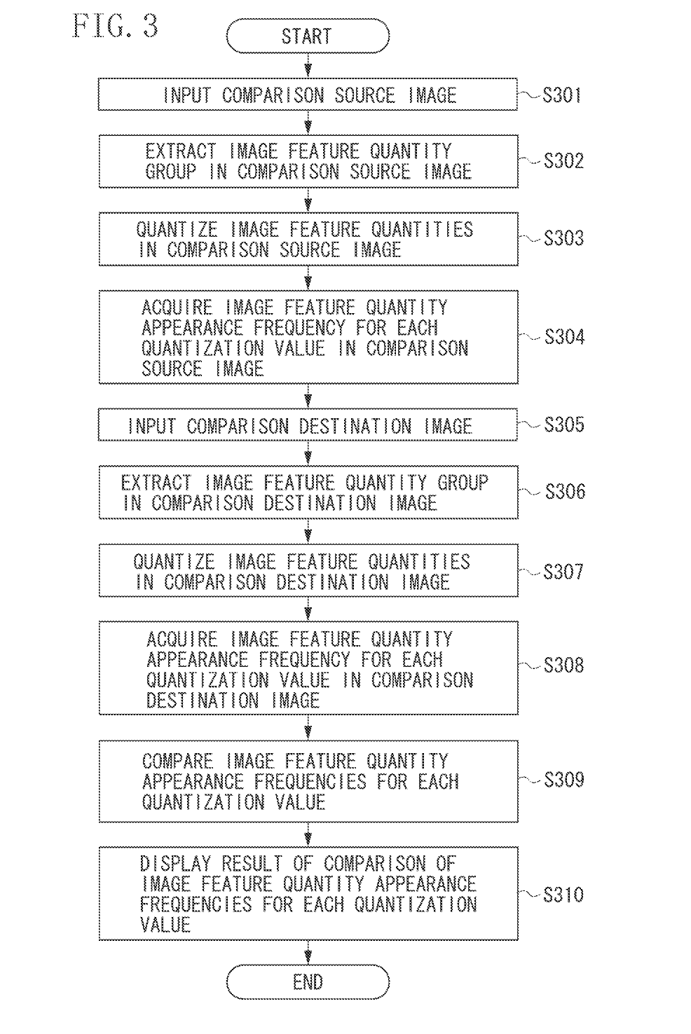

FIG. 3 is a flowchart illustrating an example of image comparison processing by the image comparison apparatus according to the first exemplary embodiment. This flowchart is implemented when the CPU executes a control program.

In step S301, the image comparison apparatus inputs a comparison source image via the image input unit 201. The input image is stored in the storage unit 207. In step S302, the image feature vector group extraction unit 202 extracts the image feature vector group from the comparison source image.

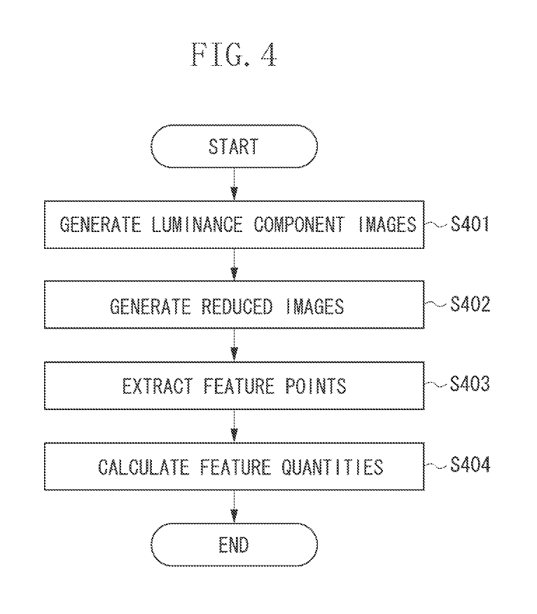

FIG. 4 is a flowchart illustrating an example of image feature vector group extraction processing in step S302. This flowchart is implemented when the CPU executes a control program. In the first exemplary embodiment, local feature vectors of the image (hereinafter simply referred to as local feature vectors) are used as image feature vectors.

In step S401, the image feature vector group extraction unit 202 extracts luminance components from the input image, and generates a luminance component image based on the extracted luminance components.

In step S402, the image feature vector group extraction unit 202 repeats reducing the luminance component image by the magnification (reduction rate) p to generate n reduced images having different sizes gradually reduced from the original size, including the original image. The magnification p and the number of reduced images n (hereinafter referred to as reduced image count) are predetermined values.

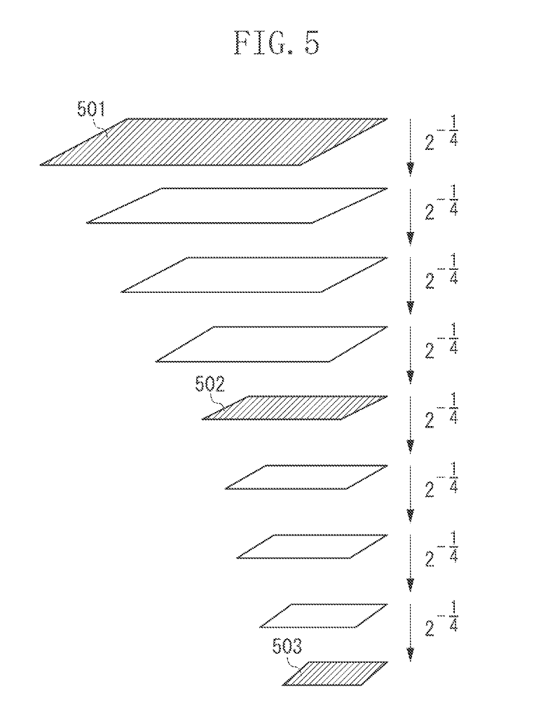

FIG. 5 illustrates an example of reduced image generation processing. The example illustrated in FIG. 5 is a case where the magnification p is the “−(¼)-th power of 2” and the reduced image count is “9”. Of course, the magnification p may be other than the “−(¼)-th power of 2”. Referring to FIG. 5, a luminance component image 501 is generated in step S401. A reduced image 502 is obtained by recursively performing four times the reduction processing on the luminance component image 501 by the magnification p. A reduced image 503 is obtained by performing eight times the relevant reduction processing on the luminance component image 501 by the magnification p.

In this example, the reduced image 502 is generated by reducing the luminance component image 501 to one half, and the reduced image 503 is generated by reducing the luminance component image 501 to one fourth. According to the first exemplary embodiment, reduced images are generated by using a method of reducing an image through linear interpolation. Image reduction may be performed by using other methods.

In step S403, the image feature vector group extraction unit 202 extracts such keypoints that are robustly extractable even after each of the n reduced images has been rotated. To extract a keypoint, in the first exemplary embodiment a method based on the Harris operator (refer to C. Harris and M. J. Stephens, “A combined corner and edge detector,” In Alvey Vision Conference, pages 147-152, 1988) is used.

More specifically, for each of the pixels on an output image H obtained by applying the Harris operator, the method checks pixel values of 9 pixels including a relevant pixel and the pixels existing at the eight neighboring positions of the relevant pixel. Then, the method extracts as a keypoint a point where the relevant pixel becomes locally maximum (the pixel value of the relevant pixel becomes the maximum among the 9 relevant pixels). Even when the relevant pixel becomes locally maximum, if the pixel value is equal to or smaller than a threshold value, the relevant point is not extracted as a keypoint.

The keypoint extraction method is not limited to the above-described method based on the Harris operator. Any other keypoint extraction methods are applicable as long as a keypoint can be extracted.

In step S404, for each of the keypoints extracted in step S403, the image feature vector group extraction unit 202 calculates feature vectors (local feature vectors) defined as invariant even after the image has been rotated. As a method for calculating local feature vectors, Local Jet and a combination of derivative functions are used in the first exemplary embodiment (refer to J. J. Koenderink and A. J. van Doorn, “Representation of local geometry in the visual system,” Riological Cybernetics, vol. 55, pp. 367-375, 1987).

More specifically, the method calculates the local feature vector V by using the following formula (1).

$$v = ( \begin{matrix}L \\ {L}_{x} {L}_{x} + {L}_{y} {L}_{y} \\ {L}_{xx} {L}_{x} {L}_{x} + 2 {L}_{xy} {L}_{x} {L}_{y} + {L}_{yy} {L}_{y} {L}_{y} \\ {L}_{xx} + {L}_{yy} \\ {L}_{xx} {L}_{xx} + 2 {L}_{xy} {L}_{xy} + {L}_{yy} {L}_{yy}\end{matrix} ) \qquad ( 1 )$$

Variable names on the right-hand side of formula (1) are defined by formulas (2) to (7) described below. Referring to the right-hand side of formula (2), G(x,y) is a Gaussian function, I(x,y) indicates pixel values at image coordinates (x, y), and “*”, indicates the convolution operation. Formula (3) is a partial derivative of a variable L with respect to x that is defined by formula (2). Formula (4) is a partial derivative of the variable L with respect to y. Formula (5) is a partial derivative of a variable Lx with respect to y that is defined by formula (3). Formula (6) is a partial derivative of the variable Lx with respect to x that is defined by formula (3). Formula (7) is a partial derivative of a variable Ly with respect to y that is defined by formula (4).

$$\begin{matrix}L = G ( x , y ) * I ( x , y ) & ( 2 ) \\ {L}_{x} = \frac{\partial L}{\partial x} & ( 3 ) \\ {L}_{y} = \frac{\partial L}{\partial y} & ( 4 ) \\ {L}_{xy} = \frac{{\partial }^{2} L}{\partial x \partial y} & ( 5 ) \\ {L}_{xx} = \frac{{\partial }^{2} L}{\partial {x}^{2}} & ( 6 ) \\ {L}_{yy} = \frac{{\partial }^{2} L}{\partial {y}^{2 }} & ( 7 )\end{matrix}$$

The feature vector calculation is not limited to the above-described method. Any other feature vector calculation methods are applicable as long as the feature vector can be calculated. Examples are a method based on the SIFT feature vector and a method based on the SURF feature vector. The method based on the SIFT feature vector segmentalizes a predetermined range around a keypoint into 16 (4×4) blocks, and generates for each block a gradient direction histogram for eight different directions in steps of 45 degrees. The 128-dimensional feature vector is used as a local feature vector.

An image feature vector group can be obtained by collecting local feature vectors for all of keypoints in the target image.

In step S303, the image feature vector quantization unit 203 quantizes each image feature vector of the image feature vector group in the comparison source image extracted in step S302 to generate a quantized image feature vector group in the comparison source image.

The image feature vector currently used in the first exemplary embodiment, i.e., the local feature vector calculated from each keypoint based on Local Jet and a combination of these derivative functions is a N-dimensional vector. In the present case, the image feature vector quantization unit 203 quantizes the feature vector of the n-th dimension among the N dimensions into Kₙ gradations, where N and Kₙ are predetermined values.

More specifically, the image feature vector quantization unit 203 performs quantization by using the following formula (8).

Qₙ=(Vₙ*Kₙ)/(Vₙ_{_{—}}ₘₐₓ−Vₙ_{_{—}}ₘᵢₙ+1) (8)

where Qₙ is a value obtained by quantizing the feature vector Vₙ of the n-th dimension among the N dimensions. Vₙ_{_{—}}ₘₐₓ and Vₙ_{_{—}}ₘᵢₙ respectively indicate maximum and minimum values the feature vector of the n-th dimension can take.

Collecting quantization values of each dimension enables obtaining of quantized image feature vectors, and collecting all of quantized image feature vectors in the target image enables obtaining of a quantized image feature vector group.

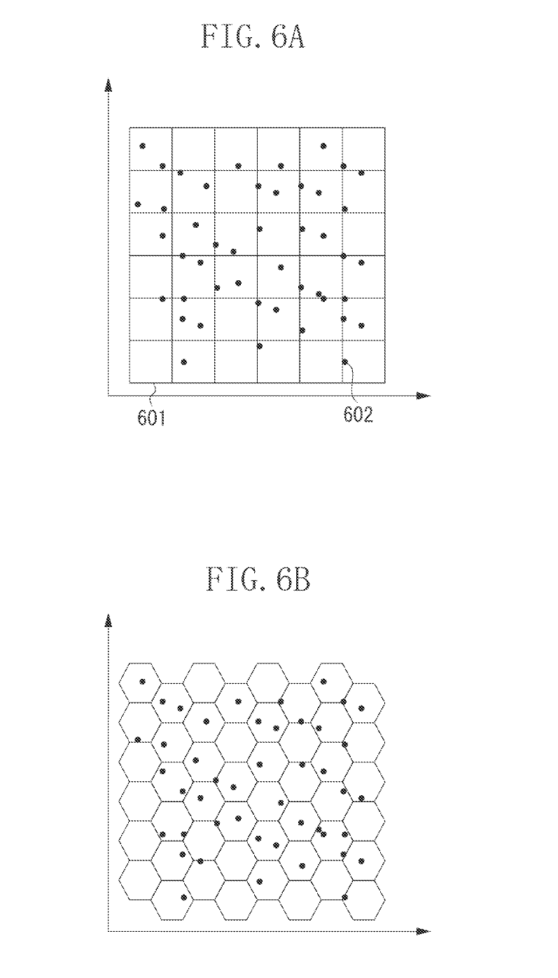

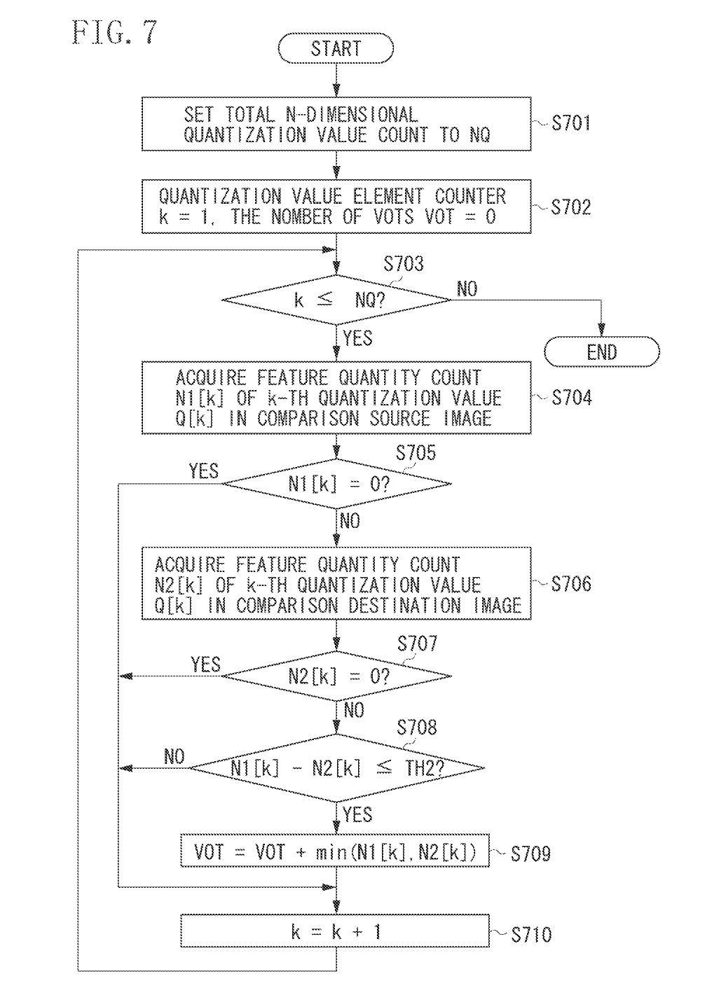

Although, in the above-described quantization, the number of quantization gradations is determined for each dimension, a common number of quantization gradations may be determined for all or some of dimensions. Although this quantization method segmentalizes the feature vector space in a lattice shape as illustrated in FIG. 6A, the feature vector space may be segmentalized in a lattice shape as illustrated in FIG. 6B. Referring to the feature vector space illustrated in FIG. 6A, a lattice area 601 indicates each quantization area and a point 602 indicates each feature. Features are associated with quantization areas. In the examples illustrated in FIGS. 6A and 6B, the two-dimensional feature vector space is segmentalized for quantization for descriptive purposes. Since the local feature vector is a multidimensional vector, such as a 128-dimensional vector, segmentalization is actually performed in a multidimensional feature vector space.

The feature vector space segmentalization method is not limited to quantization based on the above-described rule. Any other feature vector space segmentalization methods are applicable as long as the feature vector space can be segmentalized. For example, it is possible to make a clustering rule through machine learning on a plurality of images to segmentalize the feature vector space based on the rule and perform quantization.

It is also possible, after performing quantization for each dimension, to label a quantization value group by using the following formula (9) to handle the quantization value group in a way substantially similar to the one-dimensional feature vector.

IDX=Q₁+Q₂*K₁+Q₃*K₁*K₂+ . . . +Qₙ*K₁*K₂* . . . *Kₙ₋₁ (9)

When the number of gradations is common to all dimensions, it is possible to label the quantization value group by using the following formula (10), where K is the number of gradations.

$$IDX = {\sum }_{n = 1}^{N} {K}^{( n - 1 )} Qn \qquad ( 10 )$$

The calculation is not limited to the above-described method. Any other calculation methods are applicable as long as a quantization value group can be labeled.

In step S304, with respect to the quantized image feature vector group in the comparison source image generated in step S303, the quantized image feature vector frequency acquisition unit 204 acquires the image feature vector appearance frequency for each quantization value. This means the acquisition of the number of points 602 in each lattice area 601 illustrated in FIG. 6.

In step S305, the image comparison apparatus inputs a comparison destination image via the image input unit 201. The input image is stored in the storage unit 207. In step S306, the image feature vector group extraction unit 202 extracts the image feature vector group from the comparison destination image. This processing is equivalent to the image feature vector group extraction processing for the comparison source image in step S302, and detailed descriptions thereof will be omitted.

In step S307, the image feature vector quantization unit 203 quantizes each image feature vector of the image feature vector group in the comparison destination image extracted in step S306 to generate a quantized image feature vector group in the comparison destination image.

In step S308, with respect to the quantized image feature vector group in the comparison destination image generated in step S307, the quantized image feature vector frequency acquisition unit 204 acquires the image feature vector appearance frequency for each quantization value. This processing means the acquisition of the number of points 602 existing in each lattice area 601 illustrated in FIG. 6.

In step S309, the quantized image feature vector frequency comparison unit 205 compares the image feature vector appearance frequency for each quantization value in the comparison source image generated in step S304 with the image feature vector appearance frequency for each quantization value in the comparison destination image generated in step S308. The result of the comparison enables evaluation of the similarity between the comparison source image and the comparison destination image.

FIG. 7 is a flowchart illustrating an example of processing for comparing the image feature vector appearance frequencies for each quantization value in step S309. This flowchart is implemented when the CPU executes a control program.

In step S701, the quantized image feature vector frequency comparison unit 205 calculates the total number of N-dimensional quantization values by using the following formula (11), and sets the total number to NQ.

NQ=K₁*K₂*K₃* . . . *Kₙ (11)

When the number of gradations is common to all dimensions, the quantized image feature vector frequency comparison unit 205 calculates the total number of quantization values NQ by using the following formula (12).

NQ=K^{N} (12)

In step S702, the quantized image feature vector frequency comparison unit 205 sets the quantization value element counter k to 1, and sets the number of votes VOT to 0.

In step S703, the quantized image feature vector frequency comparison unit 205 compares the quantization value element counter k with the total number of quantization values NQ to determine whether k is equal to or smaller than NQ. When it is determined that k is equal to or smaller than NQ (YES in step S703), the processing proceeds to step S704. On the other hand, when it is determined that k is larger than NQ (NO in step S703), the processing exits this flowchart.

In step S704, the quantized image feature vector frequency comparison unit 205 acquires the number of feature vectors N1[k] of the k-th quantization value Q[k] in the comparison source image. In step S705, the quantized image feature vector frequency comparison unit 205 determines whether N1[k] is 0. When it is determined that N1[k] is 0 (YES in step S705), the processing proceeds to step S710. On the other hand, when it is determined that N1[k] is not 0 (NO in step S705), the processing proceeds to step S706.

In step S706, the quantized image feature vector frequency comparison unit 205 acquires the number of feature vectors N2[k] of the k-th quantization value Q[k] in the comparison destination image. In step S707, the quantized image feature vector frequency comparison unit 205 determines whether N2[k] is 0. When it is determined that N2[k] is 0 (YES in step S707), the processing proceeds to step S710. On the other hand, when it is determined that N2[k] is not 0 (NO in step S707), the processing proceeds to step S708.

In the present exemplary embodiment, in step S707, the quantized image feature vector frequency comparison unit 205 determines whether the number of feature vectors for each quantization value in the comparison destination image is 0. The processing proceeds to the following step S708 only when it is determined that the number is not 0. However, the processing may unconditionally proceed to the following step S708, omitting the determination processing in step S707. The same result will be obtained in either case. However, depending on the implementing method, one method may possibly be faster than the other. For example, when N2[k]=0, step S707 can be executed faster since steps S708 and S709 will be skipped.

In step S708, the quantized image feature vector frequency comparison unit 205 compares N2[k] with N1[k] to determine whether the absolute value of the difference between N1[k] and N2[k] (N1[k]−N2[k]) is equal to or smaller than a threshold value TH2. When it is determined that the difference is equal to or smaller than the threshold value TH2 (YES in step S708), the processing proceeds to step S709. On the other hand, when it is determined that the difference is larger than the threshold value TH2 (NO in step S708), the processing proceeds to step S710. The threshold value TH2 may be a fixed value, or variably determined based on the values of N1[k] and N2[k].

In the present exemplary embodiment, in step S708, when the number of feature vectors for a certain quantization value in the comparison source image is close to the number of feature vectors for the relevant quantization value in the comparison destination image, the processing proceeds to the following step S709. However, the processing may unconditionally proceed to the following step S709, omitting the processing in step S708. When a part of the comparison destination image is used as the comparison source image, the number of feature vectors for each quantization value may be largely different. If such an image is subjected to search, it is desirable to omit this processing. On the contrary, if a strictly identical image should be subjected to search, this processing will be effective.

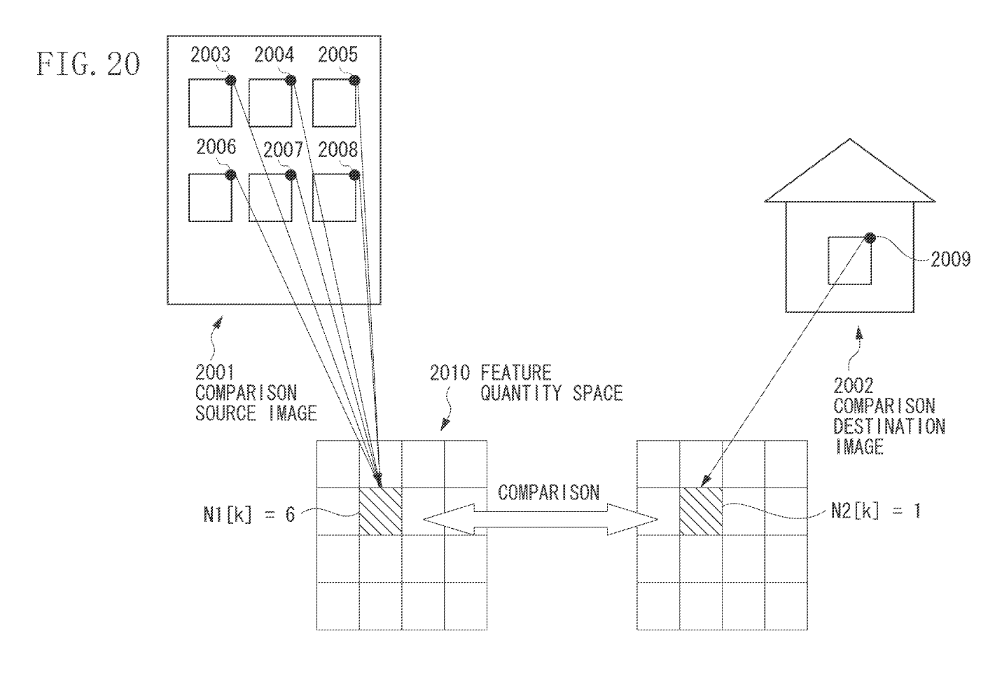

In step S709, the quantized image feature vector frequency comparison unit 205 compares N2[k] with N1[k], and adds the smaller value to the vote VOT of the comparison destination image. Specifically, as illustrated in FIG. 20, the quantized image feature vector frequency comparison unit 205 compares the number of feature vectors for each specific quantization value, and adds the smaller value to the vote VOT. The number of votes VOT is used as a value for evaluating the similarity between the comparison source image and the comparison destination image.

Although, in the present exemplary embodiment, in step S709, the quantized image feature vector frequency comparison unit 205 compares N1[k] with N2[k] and adds the smaller value to the vote VOT, the value to be added is not limited thereto. For example, the average value of N1[k] and N2[k] may be added to the vote VOT. Further, the value to be added may be determined by a value acquired by using other formulas and a look-up table. Other formulas including not only N1[k] and N2[k] but also TH2 may be used. In addition, 1 may be constantly used as the value to be added. This enables such comparison processing in which determination is made based on the number of types of feature vectors with which N1[k] is close to N2[k].

In step S710, the quantized image feature vector frequency comparison unit 205 increments k by 1, and the processing returns to step S703.

In step S310, the quantized image feature vector frequency comparison result display unit 206 displays the result of the comparison of the image feature vector appearance frequencies for each quantization value in step S309.

In the first exemplary embodiment, as described above, when comparing local feature vectors between the comparison source image and the comparison destination image, the quantized image feature vector frequency comparison unit 205 compares the similar local feature vector appearance frequencies for each quantized local feature vector. A value acquired from the smaller number among the numbers of feature vectors having the same quantization value in the comparison source image and the comparison destination image, or a predetermined value is used for voting for the comparison destination image. Thus, even if the number of similar local feature vectors (similar local feature vector appearance frequency) differs between the comparison source image and the comparison destination image, it is possible to suppress an excessive number of votes and achieve suitable evaluation.

A second exemplary embodiment of the present invention will be described below with reference to the accompanying drawings.

When the same subject is captured or the same document is scanned, binary data values differ in almost all cases. When feature vectors are extracted from the data and then quantized, there is a case where different quantization values are obtained from similar feature vectors. In the second exemplary embodiment, when comparing feature vector appearance frequencies for each quantization value between the comparison source image and the comparison destination image, the program performs comparison also by taking into consideration not only related quantization value in the comparison destination image but also the image feature vector appearance frequencies for the neighboring quantization values in the feature vector space.

Other processing is similar to that according to the first exemplary embodiment, and redundant description thereof will be omitted. The present exemplary embodiment is implemented by using a hardware configuration similar to that according to the first exemplary embodiment, and includes function units similar to those according to the first exemplary embodiment.

### [Image Comparison Processing]

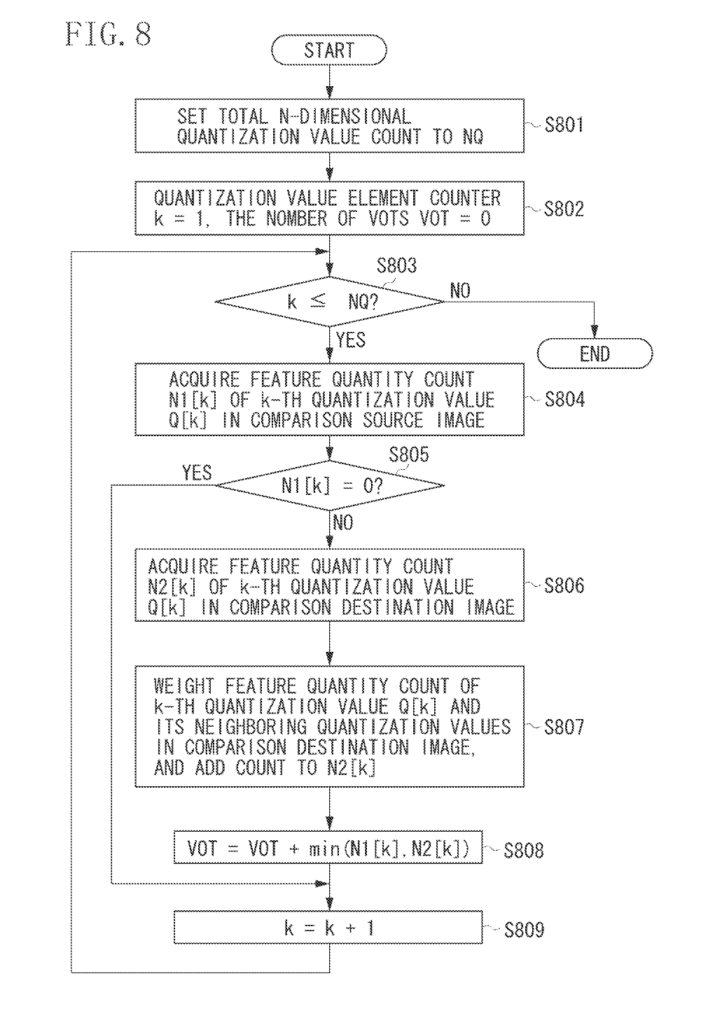

Overall processing flow according to the present exemplary embodiment is similar to that according to the first exemplary embodiment illustrated in FIG. 3. The present exemplary embodiment differs from the first exemplary embodiment in the processing for comparing the image feature vector appearance frequencies for each quantization value in step S309 illustrated in FIG. 3. This processing will be described below with reference to FIG. 8.

FIG. 8 is a flowchart illustrating an example of processing for comparing the image feature vector appearance frequencies for each quantization value according to the second exemplary embodiment. This flowchart is implemented when the CPU executes a control program.

Processing in steps S801 to S806 is similar to the processing in steps S701 to S706 according to the first exemplary embodiment.

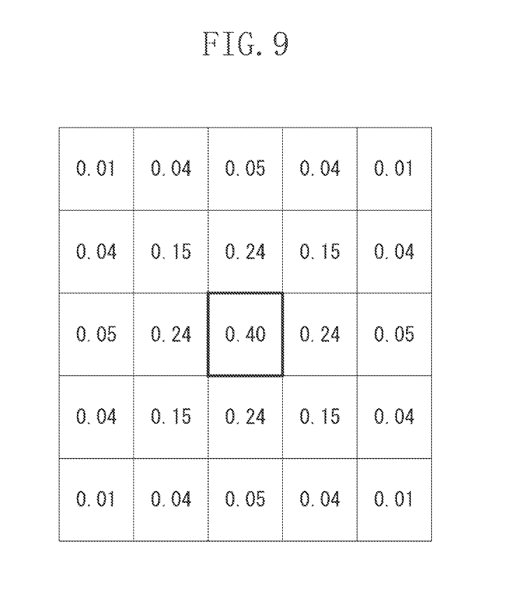

In step S807, the quantized image feature vector frequency comparison unit 205 weights the number of feature vectors of the k-th quantization value Q[k] and the neighboring quantization values in the feature vector space in the comparison destination image, and adds the resultant value to N2[k]. The weight is calculated based on the normal distribution according to the distance from Q[k]. FIG. 9 illustrates an example of weights in the two-dimensional feature vector space. The weight at the center portion is the largest. The further from the center portion the position, the smaller the weight. Although, in this example, the normal distribution with a standard deviation value of 1 is used, the standard deviation value may be changed or an original distribution may be used. If the number of feature vectors for the neighboring quantization values in the feature vector space is taken into consideration, when similar feature vectors are quantized into different quantization values in the comparison source image, duplicated addition will be performed on the same feature vectors in the comparison destination image. The influence of duplicated addition can be reduced by weighting the number of feature vectors before addition.

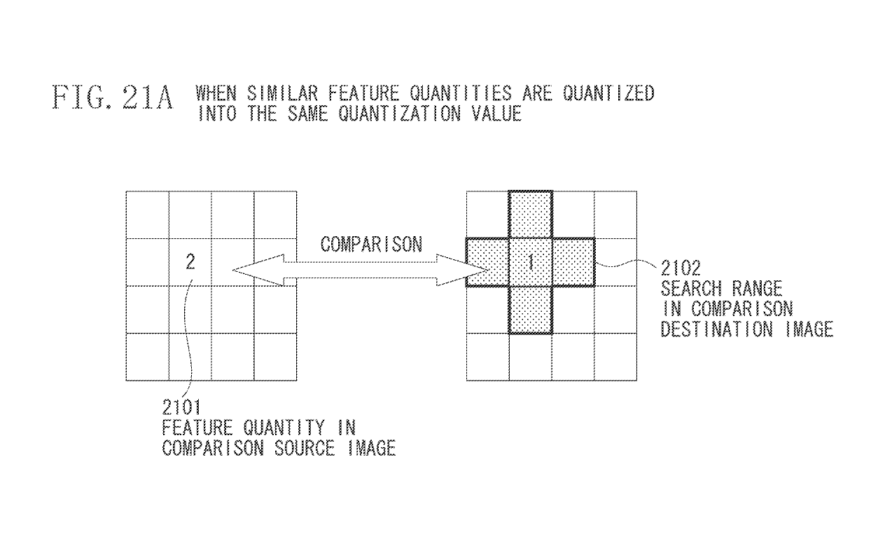

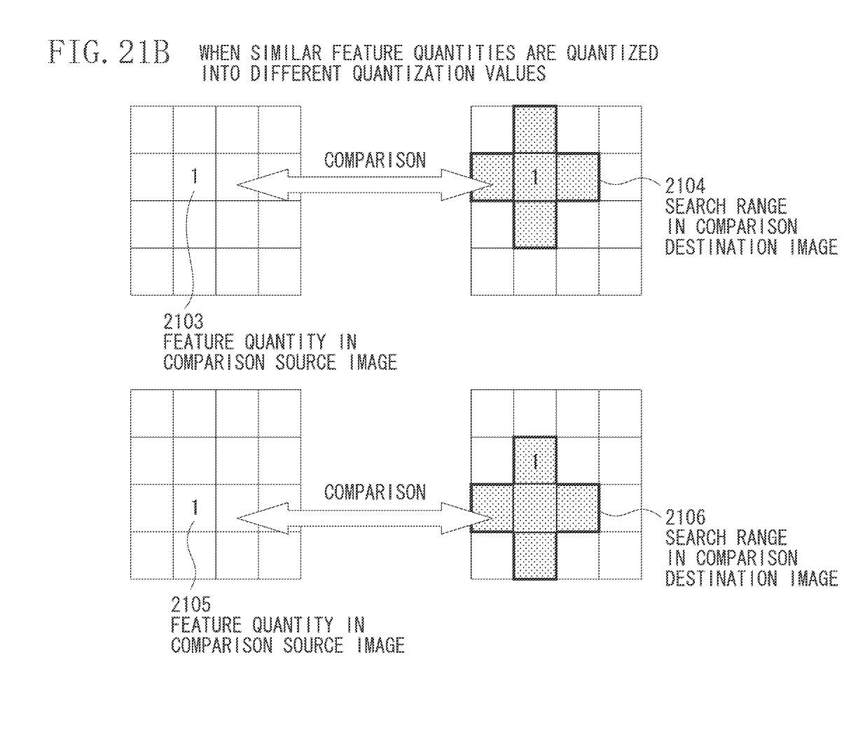

FIG. 21A illustrates an example case where similar feature vectors are quantized into the same quantization value. In this example, there are two feature vectors 2101 in the comparison source image, and there is one feature vector in a search range 2102 in the comparison destination image. When weighting is not taken into consideration, a “1” vote is cast. When weighting is taken into consideration, a “0.4” vote is cast.

FIG. 21B illustrates an example case where similar feature vectors are quantized into different quantization values. In this example, feature vectors 2103 and 2105 are quantized into different quantization values in the comparison source image. There is one feature vector 2103 in the comparison source image, and there is one feature vector in a search range 2104 in the comparison destination image. When weighting is not taken into consideration, a “1” vote is cast. When weighting is taken into consideration, a “0.4” vote is cast. Further, there is one feature vector 2105 in the comparison source image, and there is one feature vector in a search range 2106 in the comparison destination image. When weighting is not taken into consideration, a “1” vote is cast. When weighting is taken into consideration, a “0.24” vote is cast. In total, “2” votes are cast when weighting is not taken into consideration, and a “0.64” vote is cast when weighting is taken into consideration.

Although it is desirable that the examples illustrated in FIGS. 21A and 21B provide almost the same vote, it turns out that the influence of duplicated addition is reduced in a case where weighting is taken into consideration.

However, instead of the processing in step S807, it is also possible to add to N2[k] the number of feature vectors for the neighboring quantization values in the feature vector space without weighting.

Processing in steps S808 to S809 is similar to the processing in steps S709 to S710 according to the first exemplary embodiment.

In the second exemplary embodiment, as described above, the program performs comparison by taking into consideration not only the related quantization value in the comparison destination image but also the image feature vector appearance frequencies for the neighboring quantization values in the feature vector space. Thus, even if the number of similar local feature vectors largely differs between the comparison source image and the comparison destination image, an excessive number of votes can be prevented. Accordingly, even if similar local feature vectors are quantized into different quantization values, suitable evaluation can be achieved.

In the third exemplary embodiment, when comparing local feature vectors between the comparison source image and the comparison destination image, the program acquires local feature vector appearance frequencies also by taking into consideration the neighboring quantization values in the feature vector space in the comparison destination image, and then performs comparison by using the local feature vector appearance frequencies. The present exemplary embodiment is implemented by using a hardware configuration similar to that according to the first exemplary embodiment.

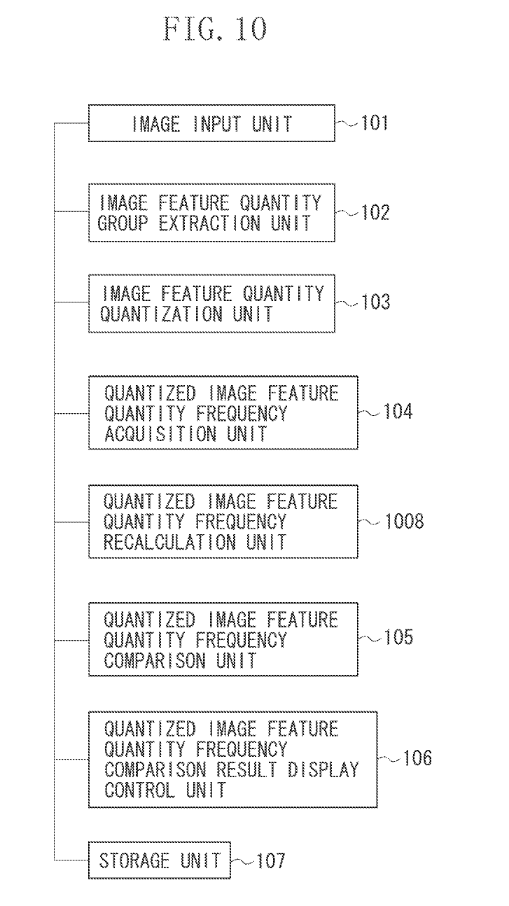

FIG. 10 is a block diagram illustrating an example of functional configuration of an image comparison apparatus according to the third exemplary embodiment. Operations of each unit illustrated in FIG. 10 will be described in detail below.

Referring to FIG. 10, the units 201 to 207 are similar to the units illustrated in FIG. 2 according to the first exemplary embodiment. A quantized image feature vector frequency recalculation unit 1008 calculates the image feature vector appearance frequency for each quantization value in the comparison destination image to take into consideration the neighboring quantization values in the feature vector space in the comparison destination image.

### [Image Comparison Processing]

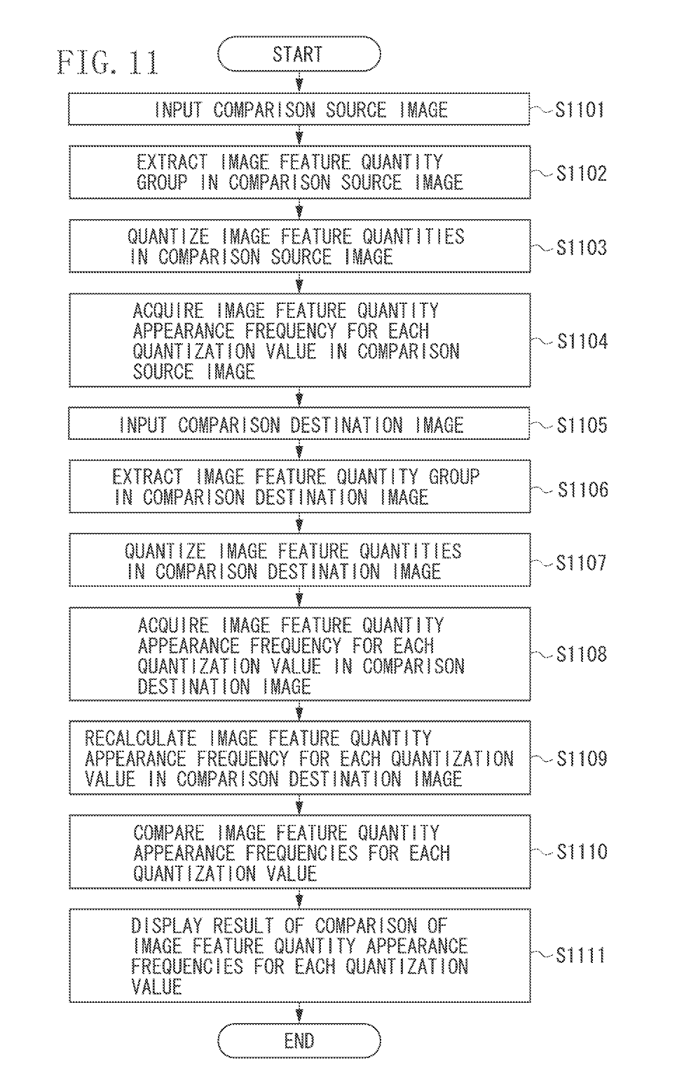

FIG. 11 is a flowchart illustrating an example of image comparison processing by the image comparison apparatus according to the third exemplary embodiment. This flowchart is implemented when the CPU executes a control program.

Processing in steps S1101 to S1108 are similar to processing in steps S301 to S308 according to the first exemplary embodiment.

In step S1109, the quantized image feature vector frequency recalculation unit 1008 recalculates image feature appearance frequency for each quantization value in the comparison destination image.

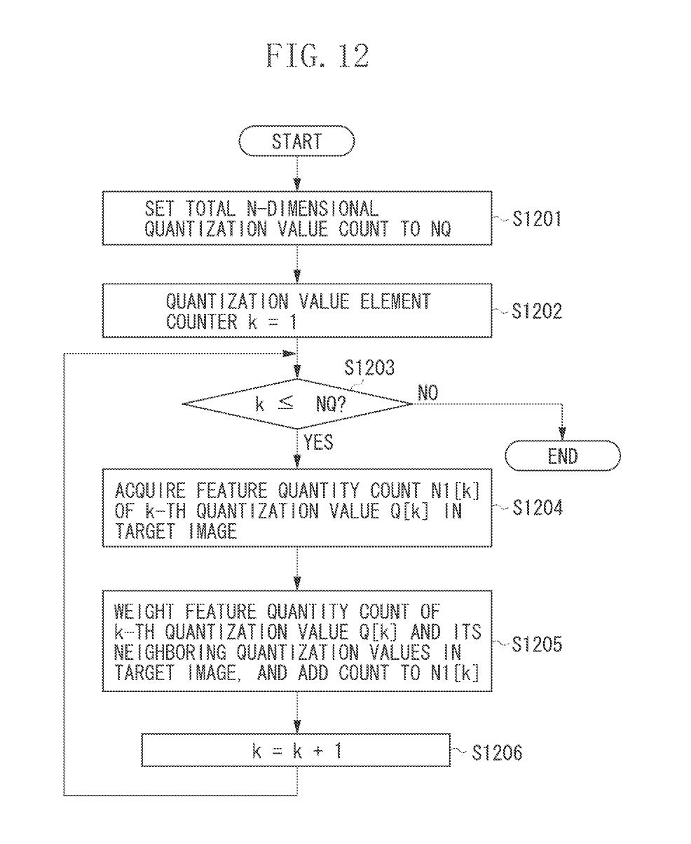

FIG. 12 is a flowchart illustrating an example of processing for recalculating the image feature vector appearance frequency for each quantization value according to the third exemplary embodiment. This flowchart is implemented when the CPU executes a control program.

Processing in steps S1201 to S1203 is similar to the processing in steps S701 to S703 according to the first exemplary embodiment.

In step S1204, the quantized image feature vector frequency comparison unit 205 acquires the number of feature vectors N1[k] of the k-th quantization value Q[k] in the target image (one of comparison target images). In step S1205, the quantized image feature vector frequency comparison unit 205 weights the number of feature vectors of the k-th quantization value Q[k] and the neighboring quantization values in the feature vector space in the target image, and adds the resultant value to N1[k]. This processing is similar to the processing in step S807 according to the second exemplary embodiment.

In step S1206, the quantized image feature vector frequency comparison unit 205 increments k by 1, and the processing returns to step S1203.

Processing in steps S1110 to S1111 is similar to the processing in steps S309 to S310 according to the first exemplary embodiment.

As described above, in the third exemplary embodiment, when comparing local feature vectors between the comparison source image and the comparison destination image, the program performs comparison by using local feature vector appearance frequencies in which the neighboring quantization values in the feature vector space in the comparison source image are also taken into consideration. Thus, even if the number of similar local feature vectors differs between the comparison source image and the comparison destination image, an excessive number of votes can be prevented. Accordingly, even if similar local feature vectors are quantized into different quantization values, suitable evaluation can be achieved.

In the fourth exemplary embodiment, when comparing local feature vectors between the comparison source image and the comparison destination image, the program acquires local feature vector appearance frequencies also by taking into consideration the neighboring quantization values in the feature vector space in the comparison source image, and then performs comparison by using the local feature vector appearance frequencies. The present exemplary embodiment is implemented by using a hardware configuration similar to that according to the first exemplary embodiment.

The functional configuration according to the fourth exemplary embodiment is similar to the functional configuration according to the third exemplary embodiment. However, referring to FIG. 10, the quantized image feature vector frequency recalculation unit 1008 recalculates the image feature vector appearance frequency for each quantization value in the comparison source image to take into consideration the neighboring quantization values in the feature vector space in the comparison source image.

### [Image Comparison Processing]

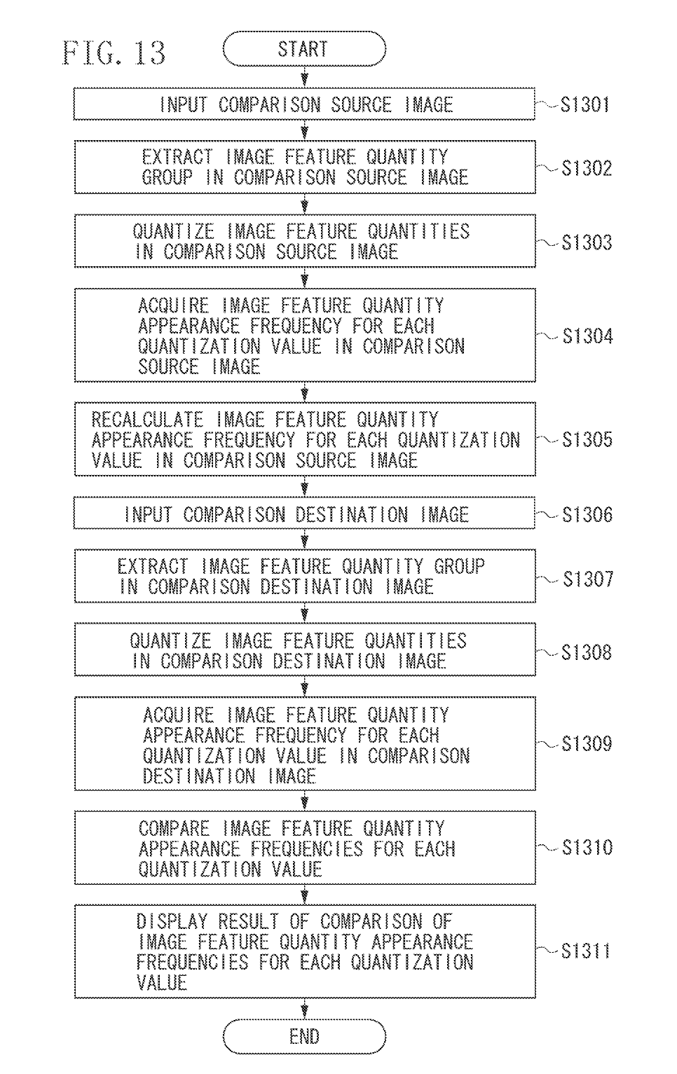

FIG. 13 is a flowchart illustrating an example of image comparison processing by the image comparison apparatus according to the fourth exemplary embodiment. This flowchart is implemented when the CPU executes a control program.

Processing in steps S1301 to S1304 is similar to the processing in steps S301 to S304 according to the first exemplary embodiment.

In step S1305, the quantized image feature vector frequency recalculation unit 1008 recalculates the image feature vector appearance frequency for each quantization value in the comparison source image. This processing is similar to the processing in step S1109 according to the third exemplary embodiment although the target image is different.

Processing in steps S1306 to S1311 is similar to the processing in steps S305 to S310 according to the first exemplary embodiment.

As described above, in the fourth exemplary embodiment, when comparing local feature vectors between the comparison source image and the comparison destination image, the program acquires local feature vector appearance frequencies also by taking into consideration the neighboring quantization values in the feature vector space in the comparison source image, and then performs comparison by using the local feature vector appearance frequencies. Thus, even if the number of similar local feature vectors (similar local feature vector appearance frequency) differs between the comparison source image and the comparison destination image, excessive number of votes can be prevented. Accordingly, even if similar local feature vectors are quantized into different quantization values, suitable evaluation can be achieved.

A fifth exemplary embodiment of the present invention will be described below with reference to the accompanying drawings.

In the fifth exemplary embodiment, the program compares the comparison source image with a plurality of comparison destination images, and arranges the result of the comparison in order of similarity.

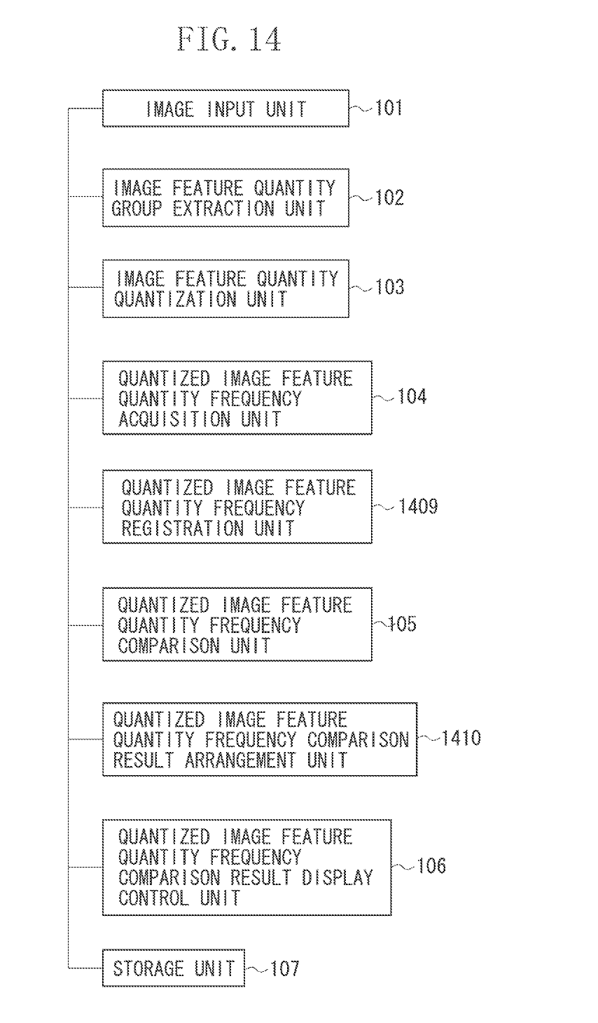

FIG. 14 is a block diagram illustrating an example of a functional configuration of an image retrieval apparatus according to the fifth exemplary embodiment. Operations of each unit illustrated in FIG. 14 will be described in detail below.

Referring to FIG. 14, the units 101 to 105 and 107 are similar to the units illustrated in FIG. 2 according to the first exemplary embodiment. A quantized image feature vector frequency registration unit 1409 registers in the storage unit 207 the image feature vector appearance frequencies for each quantization value extracted from the plurality of comparison destination images. A quantized image feature vector frequency comparison result rearrangement unit 1410 determines the order of similarity of the plurality of comparison destination images relative to the comparison source image based on the result of the comparison between the comparison source image and the plurality of comparison destination images by the quantized image feature vector frequency comparison unit 205. The quantized image feature vector frequency comparison result rearrangement unit 1410 arranges the comparison destination images in that order. A quantized image feature vector frequency comparison result display control unit 206 displays the result of the arrangement by the quantized image feature vector frequency comparison result rearrangement unit 1410.

### [Image Registration Processing]

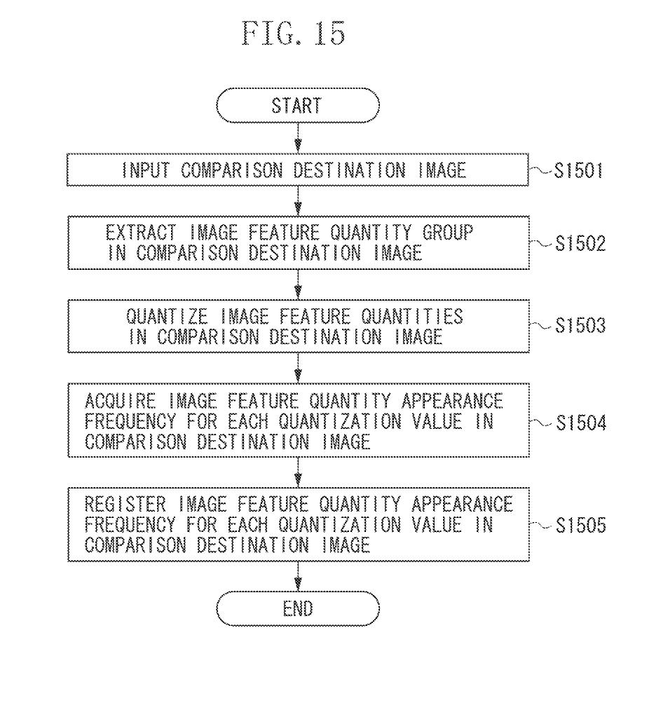

FIG. 15 is a flowchart illustrating an example of image registration processing by the image retrieval apparatus according to the fifth exemplary embodiment. This flowchart is implemented when the CPU executes a control program.

Processing in steps S1501 to S1504 is similar to the processing in steps S305 to S308 according to the first exemplary embodiment.

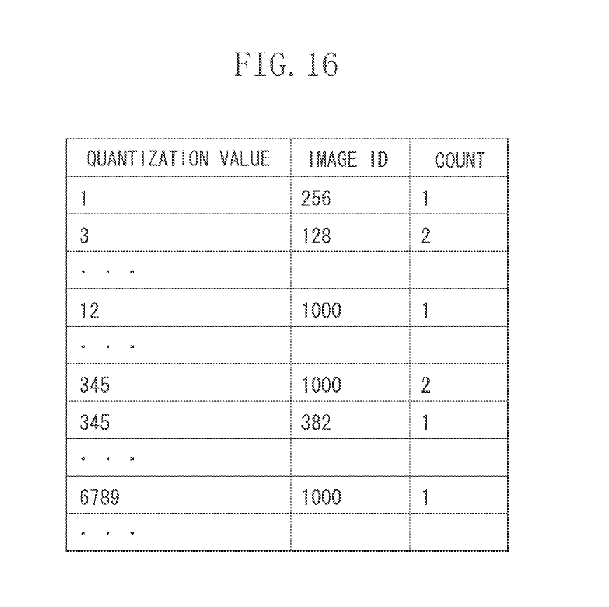

In step S1505, the quantized image feature vector frequency acquisition unit 204 registers in the storage unit 207 the image feature vector appearance frequency for each quantization value in the comparison destination image in association with the comparison destination image. FIG. 16 illustrates an example of a database in which the image feature vector appearance frequency for each quantization value is registered in association with the comparison destination image. These pieces of information are registered in the database by using the quantization value as a key. Further, an image ID is assigned to each comparison destination image, and the ID is registered in the database. Further, the quantized image feature vector appearance frequency (the number of quantized image feature vectors) is registered. When the same image is registered a plurality of times or when similar images are registered, a plurality of image IDs may be associated with one quantization value. Further, an unused quantization value may exist.

### [Image Search Processing]

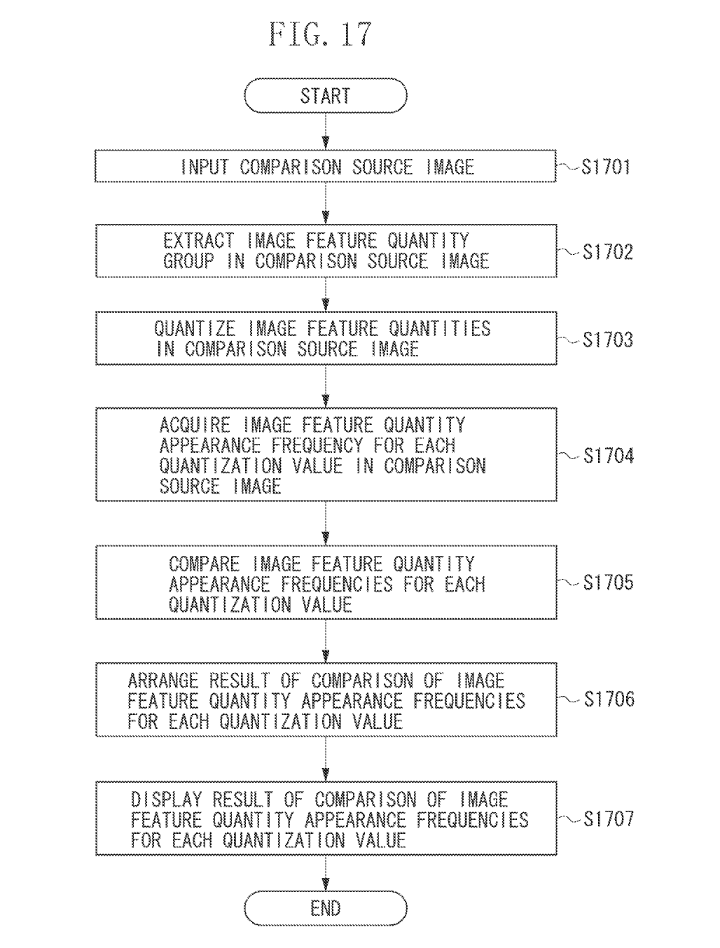

FIG. 17 is a flowchart illustrating an example of image search processing by the image retrieval apparatus according to the fifth exemplary embodiment. This flowchart is implemented when the CPU executes a control program.

Processing in steps S1701 to S1704 is similar to the processing in steps S301 to S304 according to the first exemplary embodiment.

In step S1705, for each comparison destination image, the quantized image feature vector frequency comparison unit 205 compares the image feature vector appearance frequency for each quantization value in the comparison source image generated in step S1704 with the image feature vector appearance frequency of the relevant quantization value registered in the database in step S1505. A similar index for each comparison destination image is acquired.

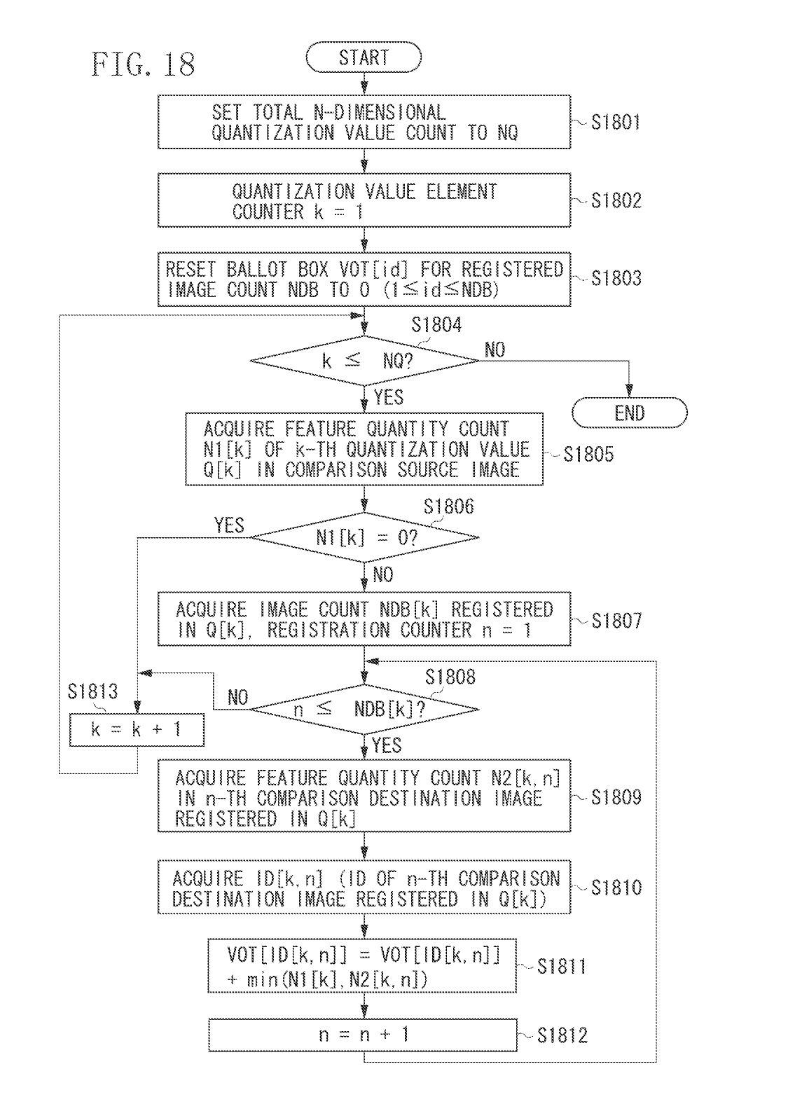

FIG. 18 is a flowchart illustrating an example of processing for comparing the image feature vector appearance frequencies for each quantization value in step S1705. This flowchart is implemented when the CPU executes a control program.

Processing in step S1801 is similar to the processing in step S701 according to the first exemplary embodiment. In step S1802, the quantized image feature vector frequency comparison unit 205 sets the quantization value element counter k to 1.

In step S1803, the quantized image feature vector frequency comparison unit 205 prepares a ballot box VOT[id] (1≦id≦NDB) for the number of images NDB registered in step S1505, and resets all of them to 0.

In step S1804, the quantized image feature vector frequency comparison unit 205 compares the quantization value element counter k with the total number of quantization values NQ. When it is determined that k is equal to or smaller than NQ (YES in step S1804), the processing proceeds to step S1805. On the other hand, when it is determined that k is larger than NQ (NO in step S1804), the processing exits this flowchart.

In step S1805, the quantized image feature vector frequency comparison unit 205 acquires the number of feature vectors N1[k] of the k-th quantization value Q[k] in the comparison source image. In step S1806, the quantized image feature vector frequency comparison unit 205 determines whether N1[k] is 0. When it is determined that N1[k] is 0 (YES in step S1806), the processing proceeds to step S1813. On the other hand, when it is determined that N1[k] is not 0 (NO in step S1806), the processing proceeds to step S1807.

In step S1807, the quantized image feature vector frequency comparison unit 205 acquires the number of images NDB[k] registered in the k-th quantization value Q[k], and sets a registration number counter n to 1.

In step S1808, the quantized image feature vector frequency comparison unit 205 compares the registration number counter n with the number of images NDB[k] registered in the k-th quantization value Q[k]. When it is determined that n is equal to or smaller than NDB[k] (YES in step S1808), the processing proceeds to step S1809. On the other hand, when it is determined that n is larger than NDB[k] (NO in step S1808), the processing proceeds to step S1813.

In step S1809, the quantized image feature vector frequency comparison unit 205 acquires the number of feature vectors N2[k,n] of the n-th comparison destination image registered in the k-th quantization value Q[k]. In step S1810, the quantized image feature vector frequency comparison unit 205 acquires the ID[k,n], i.e., the ID of the n-th comparison destination image registered in the k-th quantization value Q[k].

In step S1811, the quantized image feature vector frequency comparison unit 205 compares N1[k] with N2[k,n], and add the smaller value to the vote VOT[ID[k,n]]. In step S1812, the quantized image feature vector frequency comparison unit 205 increments n by 1, and the processing returns to step S1808.

In step S1813, the quantized image feature vector frequency comparison unit 205 increments k by 1, and the processing returns to step S1804.

In step S1706, the quantized image feature vector frequency comparison unit 205 arranges the plurality of registered comparison destination images by using the value of VOT[id]. The comparison method according to the fifth exemplary embodiment provides a larger accumulation value (the larger number of votes) for an image having a higher degree of similarity. Therefore, the quantized image feature vector frequency comparison unit 205 arranges the comparison destination images in descending order of the number of votes.

In step S1707, the quantized image feature vector frequency comparison result display unit 206 displays the result of the arrangement in step S1706, together with images related with image IDs.

Although the image retrieval apparatus according to the fifth exemplary embodiment is configured based on the image comparison apparatus according to the first exemplary embodiment, it may be configured based on the image comparison apparatus according to any one of the second to fourth exemplary embodiments. By utilizing the image comparison apparatus according to the second or the fourth exemplary embodiment, it is possible to perform evaluation of the large number of votes (high degree of similarity) even if similar local feature vectors are quantized into different quantization values. When the image comparison apparatus according to the second or the fourth exemplary embodiments is utilized, it is possible to perform search also by taking into consideration the neighboring quantization values in the feature vector space without increasing the amount of data at the time of registration. If local feature vector appearance frequencies in which the neighboring quantization values in the feature vector space are also taken into consideration are registered in advance, utilizing the image comparison apparatus according to the third exemplary embodiment enables high speed search although the amount of data at the time of registration increases.

As described above, in the fifth exemplary embodiment, when searching for an image similar to the comparison source image among the plurality of comparison destination images, the program compares similar local feature vector appearance frequencies for each quantized local feature vector, and casts a vote for each comparison destination image based on the result of the comparison. Thus, if similar local feature vector appearance frequencies differ between the comparison source image and the comparison destination image, it is possible to suppress an excessive number of votes, and suitably evaluate and search for similar images.

According to the present invention, the number of keypoints having similar local feature vectors is suitably evaluated, and therefore, it becomes possible to prevent determination that the comparison destination image has an excessive degree of similarity.

### OTHER EMBODIMENTS

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blue-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-244127 filed Nov. 26, 2013, which is hereby incorporated by reference herein in its entirety.

What is claimed is:

1. An image processing apparatus comprising:
an acquisition unit configured to acquire the number of feature vectors similar to at least one specific feature vector, including the at least one specific feature vector, among feature vectors of a plurality of keypoints in a comparison source image, and to acquire the number of feature vectors similar to the at least one specific feature vector in at least one comparison destination image; and
a comparison unit configured to compare the comparison source image with the at least one comparison destination image by using, as a value for evaluating a similarity between the comparison source image and the at least one comparison destination image, a smaller value instead of a larger value of the numbers of feature vectors acquired in the comparison source image and in the at least one comparison destination image with respect to the at least one specific feature vector.

2. The image processing apparatus according to claim 1, wherein the comparison unit uses, as a value for evaluating the similarity between the comparison source image and the at least one comparison destination image, at least one of the smaller value of the acquired numbers of feature vectors, an average value of the acquired numbers of feature vectors, and a predetermined value.

3. The image processing apparatus according to claim 1, wherein, when a difference between the number of feature vectors in the comparison source image acquired by the acquisition unit and the number of feature vectors in the at least one comparison destination image acquired by the acquisition unit exceeds a predetermined threshold value, the comparison unit omits comparison processing in which a value obtained from the acquired numbers of feature vectors is used as a similarity evaluation value.

4. The image processing apparatus according to claim 1, wherein the comparison unit casts at least one vote for the similarity evaluation value for the at least one comparison destination image, and compares the comparison source image with the at least one comparison destination image based on the number of votes.

5. The image processing apparatus according to claim 1, wherein, for each of a plurality of types of specific feature vectors, the acquisition unit acquires the number of feature vectors similar to a specific feature vector in the comparison source image, and the number of feature vectors similar to the specific feature vector in the at least one comparison destination image, and
wherein the comparison unit accumulates the similarity evaluation value for each of the plurality of types of specific feature vectors, and compares the comparison source image with the at least one comparison destination image.

6. The image processing apparatus according to claim 1, further comprising
a quantization unit configured to relate quantization values of the feature vectors with segmentalized areas in a feature vector space,
wherein the acquisition unit acquires the number of feature vectors of a quantization value in the comparison source image, associated with a first area associated with the quantization value of a first feature vector in the comparison source image, and acquires a sum total of the number of feature vectors of a quantization value in the at least one comparison destination image, associated with the first area, and the number of feature vectors of quantization values associated with neighboring areas of the first area.

7. The image processing apparatus according to claim 6, wherein the acquisition unit acquires the sum total of the number of feature vectors of quantization values, associated with the first area and the neighboring areas of the first area, and the number of feature vectors is weighted depending on which area they belong to.

8. The image processing apparatus according to claim 6, wherein the acquisition unit acquires the number of feature vectors of a quantization value in the comparison source image, associated with a second area that is one or more feature vectors of the quantization value in the comparison source image, and acquires the sum total of the number of feature vectors of a quantization value in the at least one comparison destination image, associated with the second area and the number of feature vectors of quantization values associated with neighboring areas of the second area.

9. The image processing apparatus according to claim 1, wherein the at least one comparison destination image comprises a plurality of comparison destination images and the comparison unit compares the plurality of the comparison destination images with the comparison source image, and
wherein the image processing apparatus further comprises a determination unit configured to determine an order of the plurality of the comparison destination images based on the similarity evaluation value.

10. The image processing apparatus according to claim 9, further comprising
a display control unit configured to perform control to display the plurality of comparison destination images according to the order determined by the determination unit.

11. An image processing method comprising:
acquiring the number of feature vectors similar to at least one specific feature vector, including the at least one specific feature vector, among feature vectors of a plurality of keypoints in a comparison source image, and the number of feature vectors similar to the specific feature vector in at least one comparison destination image; and
comparing the comparison source image with the at least one comparison destination image by using, as a value for evaluating a similarity between the comparison source image and the at least one comparison destination image, a smaller value instead of a larger value of the numbers of feature vectors acquired with respect to the at least one specific feature vector.

12. A non-transitory computer-readable medium storing a computer program comprising code, which when executed by a computer, causes the computer to perform the steps of:
acquiring the number of feature vectors similar to at least one specific feature vector, including the at least one specific feature vector, among feature vectors of a plurality of keypoints in a comparison source image, and the number of feature vectors similar to the at least one specific feature vector in at least one comparison destination image; and
comparing the comparison source image with the at least one comparison destination image by using, as a value for evaluating a similarity between the comparison source image and the at least one comparison destination image, a smaller value instead of a larger value of the numbers of feature vectors acquired with respect to the at least one specific feature vector.
